(19) United States
(12) Patent Application Publication
(10) Pub. No.: US 2022/0369643 A1
(43) Pub. Date: Nov. 24, 2022

(54) REPTILE AND AMPHIBIAN REPELLANT COMPOSITIONS AND METHODS OF USE

(71) Applicant: Lidia Santelices, Okeechobee, FL (US)

(72) Inventor: Lidia Santelices, Okeechobee, FL (US)

(21) Appl. No.: 17/327,592

(22) Filed: May 21, 2021

(51) Int. Cl. A01N 59/00; A01N 25/04; A01N 65/28; A01N 65/22; A01N 37/02

(52) U.S. Cl. CPC A01N 59/00; A01N 25/04; A01N 65/28; A01N 65/22; A01N 37/02

(57) ABSTRACT

A reptile and amphibian repellant composition comprising a first volume of water (H₂O) and a second volume of one or more active ingredients, wherein the one or more active ingredients is determined to have a deterring or repelling effect on a target reptile or amphibian organism, an for a deterring or repelling effect on a food source of a target reptile or amphibian organism.

### FIELD OF INVENTION

The present disclosure relates to materials and methods for pest control. More specifically, the present disclosure relates to repellant for household and commercial use in repelling and/or exterminating organisms that are generally considered as falling within the reptile and amphibian classifications.

### BACKGROUND

In residential and commercial areas, it is particularly important for the health and preservation of human and plant life, as well as maintaining the structural integrity of any dwellings, to maintain some measure of pest control with respect to a variety of wildlife organisms. Such measures oftentimes aim at controlling against the influx of insect, bat, and rodent populations. A lesser illuminated challenge is that of warding off the presence, or infestation of reptilian and amphibious-class organisms (e.g., frogs, snakes, toads, lizards, geckos, and salamanders), which are particularly commonplace in subtropical, tropical, woodland, and even in some arid desert environments. These types of organisms, especially if left uncontrolled, can become a nuisance to human, animal, and plant life, and can be potentially dangerous. For example, the mating or feeding habits of smile of these organisms may have deleterious and reverberating effects on the surrounding ecosystems, including producing piercing sounds, creating overwhelming, swarms thereby making areas inhabitable, and ruinously consuming the vegetation. Of greater concern is the worrying potential of these organisms to be venomous or poisonous, or to spread disease or bacterial infection, upon interaction. For example, reptiles and amphibians frequently carry the Salmonella bacteria, which can cause serious illness in humans that are in direct or indirect contact with the organism, the organisms droppings, or its environment. In another example, certain species of frogs and toads produce and excrete a self-protective, yet highly-toxic substance at the skin that can be lethal to house pets. Furthermore, some larger species of reptiles are carnivorous and known to bite, or otherwise attack, livestock and smallish house pets.

Additionally, an abundance of certain reptiles and amphibians can cause ecological damage, such as devegetation, alterations to boundaries of waterways or bodies of water, and structural damage to manmade dwellings (e.g., destruction to building foundations and power systems), Also, the intentional or accidental introduction of non-native species may be especially destructive to native flora and fauna, including causing a complete eradication when invasive. According to recent studies, populations of robust colonizing species are rapidly expanding and affecting ecological and economic systems worldwide due to, for example, degradation of local nutrient resources, competition with the native species, transmission of disease, spoliation of agricultural and floricultural products and shipments (and the increased costs associated with quarantine and removal), harmful transformations to various ecosystem processes, and fouling of water sources by aggressive congregation and breeding of certain species.

Various methods exist for the prevention and control of rapidly increasing reptile and amphibian populations, particularly in human-populated areas. For example, such organisms may be physically or mechanically removed by hand or by trap through capture and kill or release. Further, biological control methods may be used to gradually induce population declines, such as intentionally altering their habitats or introducing other organisms that are known to combat a target reptile or amphibian species naturally or evolutionarily. In addition, diseases that are particularly devastating to the target reptile or amphibian species may be introduced through another carrier organism. However, these existing methods suffer from several shortcomings. For example, physical or mechanical removal is oftentimes grossly inefficient when dealing with populations substantial in magnitude, such as in the case of an infestation, and across widespread areas, as the removal is typically conducted one individual organism at a time. Further, with respect to biological control methods, although their effectiveness may be comparatively more robust across an entire target population and wider swath of terrain, they are not quick solutions and take time to take effect in a wait and see approach. Additionally, they may vary in efficacy due to uncontrollable and unpredictable factors, such as environmental pattern shifts and weather conditions. And, importantly, due to the fact that biological control methods target ecological processes and equilibrium on a large scale, there is a significant risk of unintended consequences, including creating a higher resistivity in the target organism to a naturally-occurring disease, degrading the vitality of the surrounding human, animal, and plant life, and creating potentially drastic imbalances by encouraging the proliferation or en masse migration of predators and other species in competition with the target organism.

Accordingly, a need exists for targeted reptile and amphibian control methods that overcome the problems discussed above. The following disclosure primarily focuses on the ability to repel or deter as a means of safeguarding, from both harm and nuisance, the human, animal, and plant life populations in proximity to, for example, residential and commercial dwellings (e.g., houses, schools, restaurants, playgrounds, swimming pools, lakefronts, farms, etc.), as well as protecting and preserving the structural integrity and function of the dwellings themselves.

### SUMMARY

Various embodiments include a reptile and amphibian repellant composition, comprising a first volume of water (H₂O) and a second volume of one or more active ingredients, Wherein the one or more active ingredients is determined to have a deterring or repelling of on a target reptile or amphibian organism. Other embodiments include a method of administering such a reptile and amphibian repellant composition to a surface, Wherein the method comprises applying a quantity of the composition directly to an external body surface of a target organism.

Additional embodiments include a method of formulating a reptile and amphibian repellant composition, wherein the method comprises Mixing a first volume of Water (H₂O) with a second volume of one or more active ingredients, wherein the one or more active ingredients is determined to have a deterring or repelling effect on a target reptile or amphibian organism.

The one or more embodiments illustrated and described herein are not intended to be limited to the details shown because various modifications may be made therein without departing from the spirit of the disclosure and within the scope and range of equivalents of the claims. Additionally, well-known elements of exemplary embodiments will not be described in detail or will be omitted so as not to obscure the relevant details.

Other features that are considered as characteristic of the disclosure are set forth in the appended claims.

### BRIEF DESCRIPTION OF THE DRAWINGS

A more detailed description is set forth below with reference to the example embodiments depicted in the appended figures. Understanding that these figures depict only example embodiments of the disclosure and are, therefore, not to be considered limiting of its scope, the disclosure is described and explained with added specificity and detail through the use of the accompanying drawings in which:

FIG. 1 is a diagram depicting constituent parts of a reptile and amphibian repellant composition, in accordance with an exemplary embodiment:

FIG. 2 is a diagram depicting constituent parts of a reptile and amphibian repellant composition, in accordance with a further exemplary embodiment;

FIG. 3 is a flow diagram, generally illustrating the steps of formulating a reptile and amphibian repellant composition, such as the one depicted in FIG. 1, in accordance with an exemplary embodiment;

FIG. 4 is a flow diagram generally illustrating the steps of formulating a reptile and amphibian repellant composition, such as the one depicted in a FIG. 2, in accordance with an exemplary embodiment; and

FIG. 5 illustrates various methods of applying a reptile and amphibian repellent composition, such as the compositions of FIGS. 1 and 2, in accordance with an exemplary embodiment.

### DETAILED DESCRIPTION

The following description is directed to various exemplary embodiments of the disclosure. Although one or more of these embodiments May be preferred, the embodiments disclosed should not be interpreted, or otherwise used, as limiting the scope of the disclosure, including the claims. In addition, one skilled in the art will understand that the following description has broad application, and the detailed explanation of any specific embodiment is meant only to be exemplar of that embodiment and is not intended to suggest that the scope of the disclosure, including the claims, is limited to that particular embodiment.

Regarding the use herein of terms such as “an embodiment,” “one embodiment,” an “exemplary embodiment,” a “particular embodiment,” or other similar terminology, these terms are intended to indicate that a specific feature, structure, function, operation, or characteristic described in connection with the embodiment is found in at least one embodiment provided in the present disclosure. Thus, the appearances of phrases such as “in one embodiment,” “in an embodiment,” “in an exemplary embodiment” etc., may, but do not necessarily, all refer to a same embodiment, but rather, mean “one or more but not all embodiments” unless expressly specified otherwise. Further, the terms “comprising,” “having,” “including,” and variations thereof, are used in an open-minded manner and, therefore, should be interpreted to mean “including, but not limited to . . . ” unless expressly specified otherwise. Also, an element that is preceded by “comprises . . . a” does not, without more constraints, preclude the existence of additional identical elements in the subject process, method, system, article, or apparatus that comprises the element.

The terms “a,” “an,” and “the” also refer to “one or more” unless expressly specified otherwise. The term “plurality,” as used herein, is defined as two or more than two. The term “another,” as used herein, is defined as at least a second or more. Additionally, the phrase “at least one of A and B” as may be used herein and/or in the following claims, whereby A and B are variables indicating a particular object or attribute, indicates a choice of A or B, or both A and B, similar to the phrase “and/or.” Where more than two variables are present in such a phrase, this phrase is hereby defined as including only one of the variables, any one of the variables, any combination (or sub-combination) of any of the variables, and all of the variables.

Relational terms such as first and second, top and bottom, and the like might be used solely to distinguish one entity or action from another entity or action without necessarily requiring or implying any actual such relationship or order between such entities or actions. Further, where used herein, the term “about” or “approximately” applies to all numeric values, whether or not explicitly indicated. These terms generally refer to a range of numeric values that one of skill in the art would consider equivalent to the recited values (e.g., having the same function or result). In certain instances, these terms may include numeric, values that are rounded to the nearest significant figure.

In addition, any enumerated listing of items that is set forth herein does not imply that any or all of the items listed are mutually exclusive and/or mutually inclusive of one another, unless expressly specified otherwise.

In the detailed description that follows, reference is made to the appended drawings, which form a part thereof. It is recognized that the foregoing summary is illustrative only, and is not intended to be limiting in any manner. In addition to the illustrative aspects, example embodiments, and features described above, additional aspects, exemplary embodiments, and features will become apparent by reference to the drawings and the detailed description below. The description of elements in each figure may refer to elements of proceeding figures. Like reference numerals may refer to like elements in the figures, including alternate exemplary embodiments of like elements.

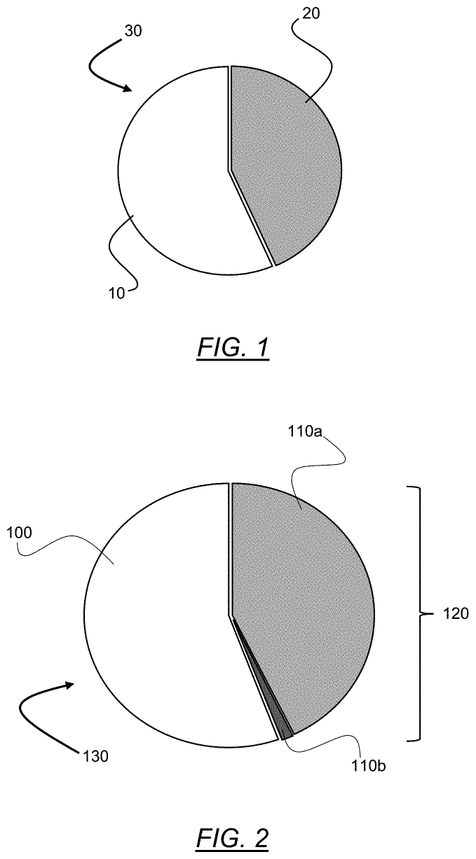

Referring now to the drawings in detail and beginning with FIG. 1, there is a pie-type diagram depicting constituent parts 10, 20 of a reptile and amphibian repellant composition, according to an exemplary embodiment thereof. As is described in specific detail below, the composition according, to this particular embodiment is an aqueous solution in liquid form. However, it may be possible to form a composition having the same resulting chemical properties using constituents in solid (e.g., powdery or granular) form, gaseous (e.g., steam) form, and/or in a semi-solid or semi-liquid, viscous (e.g., a gel) form. Further, while specific ingredients for constituents 10, 20 are identified in the description below, a myriad of other suitable ingredients having similar chemical properties and/or reactivities to the identified ingredients may be interchanged therein. In addition, in the exemplary embodiments that are described below, specific volumetric, quantities and ingredient ratios of the constituents are indicated. However, any suitable quantity and/or ratio of the constituents that results in the composition having a similar efficacy may be employed. Accordingly, the exemplary embodiments described herein are intended to be only illustrative and non-limiting in their nature.

As indicated in FIG. 1, the composition according to this particular embodiment is comprised of a solution of a first volume 10 of water (i.e., hydrogen dioxide, or H₂O) and a second volume 20 comprised of one or more ingredients that can be characterized as “active ingredients.” For purposes of this disclosure, an “active ingredient” may be defined as any organic or inorganic substance that, at a certain quantity and in one or more forms, has a deterrent, repellant, agitating, and/or lethal effect, either directly or indirectly, upon interaction with a reptilian and or an amphibious organism, and/or a food source (e.g., mosquitos) of a reptilian and /or amphibious organism, and is mixable or soluble with water (H₂O) to form an aqueous or semi-aqueous solution. Examples of an “active ingredient” may include, but are not limited to, ammonia (NH₃), ammonium hydroxide (NH₄OH), essential or extracted oils such as tea tree oil (which contains the compound, teminene-4-ol, is derived from the leaves of the Australian plant Melaleuca alternifolia, and is known to kill certain bacteria, viruses, and/or fungi, making it a capable antimicrobial agent), mint or peppermint oil (which is primarily comprised of the chemical compounds terpene, alcohol and menthol, and is extracted from the leaves of the mint or peppermint plant, which is an aromatic herb and, therefore, the extracted oil naturally repels due to its smell and/or the ability to mask or cover up the scent of other compounds, such as phemmones, used to communicate between organisms), rosemary oil, lemongrass oil, and lavender oil, as well as biodegradable acidic compounds that include, for example, vinegar, acetic acid (CH₃COOH), malic acid (c₄H₆O₅), and citric acid (C₆H₈O₇).

Still referring to FIG. 1, as depicted, the first volume 10, according to this particular embodiment, is greater in volume than the second volume 20, and the first and second volumes combine to form a total volume 30. Further according to this specific embodiment, the first volume 10 comprises approximately 60% of the total volume 30 and the second volume 20 comprises approximately 40% of the total volume 30. The resulting composition may be in liquid form, wherein the original form of the one or more “active ingredients” could also be liquid or, alternatively, is a solid or a semi-solid/semi-liquid form sufficiently dissolved or dispersed upon combining or intermingling with the aqueous first volume 10 to form the total volume 30.

Continuing on to FIG. 2, there is depicted a pie-type diagram that illustrates the constituent parts 100, 120 of a composition of a reptile and amphibian repellant according to a further exemplary embodiment thereof. Similar to the exemplary embodiment of FIG. 1, this composition may be comprised of a solution of a first volume 100 of water (i.e., hydrogen dioxide, or H₂O) and a second volume 120 comprised of one or more compounds that can be characterized as “active ingredients,” wherein the first volume 100 is greater than the second volume 120, and the first and second volumes combine to form a total volume 130. Further, similarly, the first volume 100 comprises approximately 60% of the total volume 130 and the second volume 120 comprises approximately 40% of the total volume 130. Likewise, the resulting composition may be in liquid form, wherein the original form of the one or more “active ingredients” is also a liquid or, alternatively, may be a solid form or a semi-solid/semi-liquid form sufficiently dissolved or dispersed upon combining or intermingling with the aqueous first volume 100.

Focusing further as to the specific elements comprising the second volume 120, the second volume 120 may be further delineated into a first volume 110a of a first “active ingredient” and a second volume 110b of one or more secondary “active ingredients,” wherein the first and second volumes 110a, 110b combine to form volume 120. Additionally, as depicted, the first volume 110a may comprise a substantial majority of the volume 120, e.g., greater than approximately three-quarters (¾) of volume 120. For example, the first volume: 110a may comprise between approximately 75% and 99.9% of the volume 120, thereby comprising between approximately 30% and 39.96% of the total volume 130. As such, the second volume 110b may comprise between approximately 0.1% and 2.5% of volume 120, thereby comprising between approximately 0.04% and 10% of the total volume 130. In the illustrative example depicted in FIG. 2, the first “active ingredient” volume 110a constitutes approximately 38% of total volume 130, and the second “active ingredient(s)” volume Hob constitutes approximately 2% of total volume 130.

In addition, the first “active ingredient” comprising the first volume 110a may be comprised of a substance that has chemical properties that are characteristics of a “basic” compound, as indicated by a pH scale. Such a compound may be a “weak base”(i.e., less than 100% ionized in an aqueous solution) or a “strong base”(i.e., 100% ionized in an aqueous solution), wherein ionization refers to the dissociation of the OH ions upon reaction. Both ammonia (NH₃) and ammonium hydroxide (NH₄OH) are suitable example bases for the first “active ingredient” comprising volume 110a. Both ammonia and ammonium hydroxide have strong pungent odors at certain concentrations that can repel or deter reptile and amphibian organisms, and/or a food source of the target pest(s), just by their unpleasantness, or because they may mimic smells associated with excretions from certain predators. Further, at certain concentration and absorption levels, ammonia and ammonium hydroxide are considered toxic to vertebrates and, as such, may be employed as a lethal agent, if desired, when placed in direct contact with the anatomy of an organism.

Conversely, one or more of the secondary “active ingredient(s)” comprising the second volume 110b may be comprised of one or more substances having chemical properties characteristic of an “acidic” compound, as indicated by a pH scale. More specifically, such a compound may be a “weak acid”(i.e., less than 100% ionized in an aqueous solution) or a “strong acid”(i.e., 100% ionized in an aqueous solution), wherein ionization refers to the dissociation of the H⁺ ions upon reaction. Examples of suitable acidic compounds for use as a secondary “active ingredient” may include, but are not limited to, vinegar, acetic acid (CH₃COOH), malic acid (C₄H₆O₅), and citric acid (C₆H₅O₇). In addition, one or more of the secondary “active ingredient(s)” may comprise a variety of naturally-occurring essential or extracted oils that are derived from a plant (e.g., peppermint oil, tea tree oil, lavender oil, rosemary oil, and lemongrass oil). As mentioned above, these acidic substances and essential oils may be selected for the combinability, stability, and their resulting aroma when combined. They similarly exude strong scents that may be off-putting to reptile and amphibian organisms, and/or a food source of the target pests), anchor may mimic or mask certain vital chemical signals that are used to communicate by the target organisms (or their respective predators), thereby causing confusion, mistake, or fear, thus warding off the target organisms themselves. Advantageously, these naturally-occurring acidic substances and essential oils may be biodegradable and do not represent a significant toxicity risk to humans, mammals, and surrounding flora.

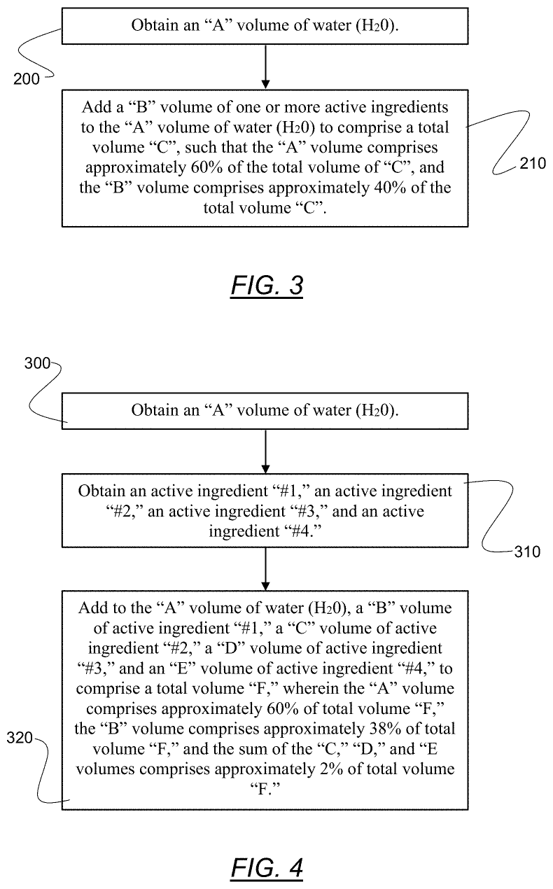

Referring now to FIG. 3, there is depicted a flow diagram of a method of formulating a reptile and amphibian repellant composition according to an exemplary embodiment. More specifically, this exemplary method is intended to result in a composition of the type that is described above with respect to the embodiment portrayed in FIG. 1. Although the steps specified in FIG. 3 are set forth in a seemingly apparent sequence, this is only for purposes of illustration and is not intended to limit the steps to any precise order of events. The prescribed steps may be performed according to any order and any sub-order. In a first step 200, an “A” volume of water (hydrogen dioxide, H₂O) is obtained. In a second step 210, a “B” volume of one or more “active ingredients” is added to the “A” volume of water to comprise an aqueous solution of a total volume “C”. In this particular embodiment, the “A” volume of water and the “B” volume of “active ingredient(s)” combine such that the “A” volume comprises approximately 60% of the total volume “C,” and the “B” volume comprises approximately 40% of the total volume “C.” Further, the resulting composition may be thoroughly mixed for optimal results.

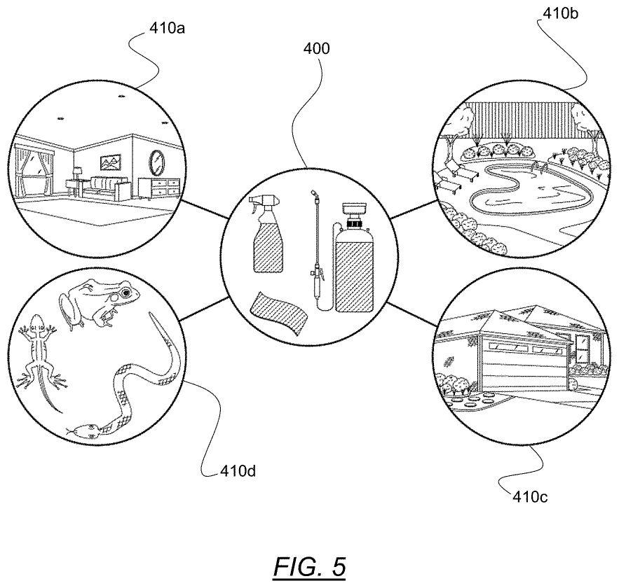

In a similar manner, set forth in FIG. 4 is a flow diagram of a method of formulating a reptile and amphibian repellant composition according to a further exemplary embodiment, wherein the resulting composition may be of the type described above with respect to FIG. 2. Again, it is important to note that although the process steps delineated in FIG. 4 are placed according to a sequence, performance of the steps is not limited to any particular order. Beginning at step 300, an “A” volume of water (H₂O) is obtained. Next, at step 310, an “active ingredient #1,” an “active ingredient #2,” an “active ingredient #3,” and an “active ingredient #4” are obtained. Further, at step 320, a “B” volume of “active ingredient #1,” a “C” volume of “active ingredient #2,” a “D” volume of “active ingredient #3,” and a “E” volume of “active ingredient #4” are added to the “A” volume of water (H₂O) to comprise an aqueous solution of a total volume “F.” According to this exemplary embodiment, the “A” volume comprises approximately 60% of the total volume “F,” the “B” volume comprises approximately 38% of the total volume “F,” and the aggregate sum of the “C,” “D,” and “F” volumes comprises approximately 2% of the total volume “F.” As indicated above, the resulting composition may be thoroughly mixed for optimal results.

For example, a reptile and amphibian repellant composition in consonance with the compositions generally set forth in the exemplary embodiments depicted in FIGS. 1-4 may be specifically comprised of approximately eight (8) cups (˜60% of the total volume) of water (H₂O), approximately five (5) cups (˜38% of the total volume) of ammonia, approximately two (2) tablespoons of tea tree oil, approximately two (2) tablespoons of peppermint oil, and approximately one-eighth (⅛) of a teaspoon of citric acid, wherein the aggregate volume of tea tree oil, peppermint oil, and citric acid is approximately 2% of the total volume of the composition.

As indicated above, the exemplary embodiments of a reptile and amphibian repellant composition described supra result in an aqueous, or partially-aqueous, liquid solution. Accordingly, methods of applying the composition during use may comprise any suitable method for evenly, or directionally, applying or distributing a liquid substance to an area. Depicted in FIG. 5 are various examples of illustrative types of distribution mechanisms that may be manually operated. As shown at 400 in FIG. 5, examples of manual distribution mechanisms may include, but are not limited to, a spray or spritz bottle, a towel/cloth, or a commercial-type or bulk-sized tank or container sprayer (e.g., a pressurized gallon backpack-type sprayer having a controllable nozzle). The reptile and amphibian repellant compositions may be applied to any surface, and at any effective concentration and amount, to create a temporary physical barrier that can deter or repel the target organisms, and/or a food source thereof, from, for example, advancing past it. Accordingly, the reptile and amphibian repellant compositions may be administered near or around human (or animal) dwellings, or near or around outdoor environments that are especially attractive to the feeding, mating, and subsisting behavior of reptiles and amphibians, such as vegetation, aquatic settings, and warm smooth surfaces (e.g., paved walkways). Further, the reptile and amphibian repellant compositions may need to be reapplied periodically according to a schedule that, based upon factors such as weather conditions (e.g., rainfall causing dilution or heat causing evaporation of the repellant composition), potency, and other external circumstances, is determined to be effective in obtaining the desired repelling and/or deterring effect. Depicted at 410a, 410b, and 410c in FIG. 5 are various illustrative scenarios or locations in which the reptile and amphibian repellant compositions, may be applied. These locations may include, but are not limited to, indoors (410a) along the walls, floors, baseboards, windows, furniture, and lounging/eating areas, in a backyard (410b) near and around walkways, furniture, umbrellas or other types of shade-fostering structures, landscaped/wild vegetation, swimming pools, and decorative ponds, and in a front yard (410c) near and around paved driveways, garages, and entryways into a house. Likewise, the reptile and amphibian repellant compositions may also be applied to similar structures and environments existing in a rural setting (e.g., a barn, livestock feed or watering area, crop fields, etc.) and a commercial setting or context (e.g., restaurants, recreational outdoor spaces, plant nurseries, farm stands, etc.).

Additionally, the reptile and amphibian repellant compositions may also be applied directly to the skin surface of the target organism (see 410d in FIG. 5) when a particularly accelerated or vigorous, and perhaps lethal, result is desired.

The foregoing description and accompanying drawings illustrate the principles, exemplary embodiments, and several modes of operation of the disclosed compositions. However, the disclosure should not be construed as limited to the particular embodiments discussed above. Additional variations of the example embodiments discussed above will be appreciated by those skilled in the art and the described embodiments should be regarded as illustrative rather than restrictive. Accordingly, it should be appreciated that variations to those embodiments can be made by those skilled in the art without departing from the scope of the disclosure as defined by the following claims.

What is claimed is:

1. A reptile and amphibian repellant composition, comprising:
a first volume of water and
a second volume of one or more active ingredients, wherein the one or more active ingredients is determined to have a deterring or repelling effect on a target reptile or amphibian organism.

2. The composition according to claim 1, wherein the one or more active ingredients is determined to have a deterring or repelling effect on a food source of the target reptile or amphibian organism.

3. The composition according to claim 1, Wherein the composition is in a liquid, aqueous form.

4. The composition according to claim 1, wherein the first volume is greater in magnitude than the second volume.

5. The composition according to claim 1, wherein the composition has a total volume and:
the first volume is approximately 60% of the total volume; and
the second volume is approximately 40% of the total volume.

6. The composition according to claim 1, wherein the one or more active ingredients comprise at least one of:
a weak base compound according to a corresponding pH level; and
a weak acid compound according to a corresponding pH level.

7. The composition according to claim 1, wherein the composition has a total volume and:
the one or more active ingredients comprise ammonia, wherein the ammonia comprises a third volume; and the third volume is approximately 38% of the total volume.

8. The composition according to claim 7, wherein:
the one or more active ingredients further comprise tea tree oil, pepper in oil, and citric acid; and
an aggregate, volume of the tea tree oil, peppermint oil, and citric acid is approximately 2% of the total volume.

9. The composition according to claim 8, wherein:
the first volume is approximately eight cups;
the second volume is approximately five cups;
a volume of the tea tree oil is approximately two tablespoons;
a volume of the peppermint oil is approximately two tablespoons; and
a volume of the citric acid is approximately one-eighth of a teaspoon.

10. A method of administering the composition of claim 1 to a surface, the method comprising applying a quantity of the composition directly to an external body surface of the target organism.

11. A method of formulating a reptile and amphibian repellant composition, the method comprising:
mixing a first volume of water with a second volume of one or more active ingredients, wherein the one or more active ingredients is determined to have a deterring or repelling effect on a target reptile or amphibian organism.

12. The method according to claim 11, wherein the one or more active ingredients is determined to have a deterring or repelling effect on a food source of the target reptile or amphibian organism.

13. The method according to claim 11, wherein a ratio of the first volume to the second volume is such that the composition is in a liquid, aqueous form.

14. The method according to claim 11, wherein the first volume is greater in magnitude Thai the second volume.

15. The method according to claim 11, wherein the composition has a total volume and:
the first volume is approximately 60% of the total volume; and
the second volume is approximately 40% of the total volume.

16. The method according to claim 11, Wherein the one or more active ingredients comprise at least one of:
a weak base compound according to a corresponding pH level; and
a weak acid compound according to a corresponding pH level.

17. The method according to claim 11, wherein the composition has a total volume and:
the one or more active ingredients comprise ammonia, wherein the ammonia comprises a third volume; and
the third volume is approximately 38% of the total volume.

18. The method according, to claim 17, wherein:
the one or more active ingredients further comprise tea tree oil, peppermint oil, and citric acid; and
an aggregate volume of the tea tree oil, peppermint oil, and citric acid is approximately 2% of the total volume.

19. The method according to claim 18, wherein:
the first volume is approximately eight cups;
the second volume is approximately five cups;
a volume of the tea tree oil is approximately two tablespoons;
a volume of the peppermint oil is approximately two tablespoons; and
a volume of the citric acid is approximately one-eighth of a teaspoon.
